(19) United States
(12) Patent Application Publication
(10) Pub. No.: US 2021/0120809 A1
(43) Pub. Date: Apr. 29, 2021

(54) VASCULAR TISSUE PERFUSION APPARATUS, SYSTEMS, AND METHODS

(71) Applicant: THE BOARD OF REGENTS OF THE UNIVERSITY OF TEXAS SYSTEM, Austin, TX (US)

(72) Inventor: Leonid BUNEGIN, San Antonio, TX (US)

(73) Assignee: THE BOARD OF REGENTS OF THE UNIVERSITY OF TEXAS SYSTEM, Austin, TX (US)

(21) Appl. No.: 17/251,903

(22) PCT Filed: Jun. 20, 2019
(86) PCT No.: PCT/US2019/038260

§ 371 Date: Dec. 14, 2020

Related U.S. Application Data
(60) Provisional application No. 62/811,127, filed on Feb. 27, 2019.
(60) Provisional application No. 62/687,353, filed on Jun. 20, 2018.

(51) Int. Cl. A01N 1/02

(52) U.S. Cl. CPC A01N 1/0247

(57) ABSTRACT

Devices and methods for vascular tissue perfusion. In certain examples, the pressurized oxygen is repetitively pulsed between a lower pressure and a higher pressure and a flexible membrane is deflected to control fluid flow.

### BACKGROUND

In combat and mass casualty situations, particularly where detonations have occurred, a significant number of severed extremities may appear. In order to facilitate replantation, extremities should be promptly preserved from deterioration, often for several hours to several days, so that the patient can be transported to a medical facility and stabilized before replantation is attempted.

Existing devices can be difficult to use under field conditions, due to limitations of size, weight, the availability of electrical power, operator training, etc. These limitations can lead to significant delays in the time before preservation of the tissue can begin, reducing the length of time during which transport can be performed. Moreover, the transport time is often further limited, because available devices cannot provide an environment that sustains the viability of the tissue for any longer than a few hours. This problem is especially apparent when internal organs are transported from one location to another, as part of a long-distance transplant operation.

### BRIEF DESCRIPTION OF THE DRAWINGS

The following drawings form part of the present specification and are included to further demonstrate certain aspects of the present disclosure. Various examples may be better understood by reference to one of these drawings in combination with the detailed description of specific examples presented herein.

FIG. 1 shows an exploded view of an example of an apparatus for vascular tissue perfusion according to the present disclosure.

FIG. 2 shows a partial section view of the example of FIG. 1.

FIG. 3 shows a system and a perspective section view of the example of FIG. 1.

FIG. 4 shows a partial section view of particular components of the example of FIG. 1 in a first position.

FIG. 5 shows a partial section view of particular components of the example of FIG. 1 in a second position.

FIG. 6 shows a partial section view of particular components of the example of FIG. 1 in a third position.

FIG. 7 shows a flow diagram of a method of perfusing tissue, according to various examples.

FIG. 8 shows a graph of a perfusate oxygenation profile illustrating oxygen partial pressure over time.

FIG. 9 shows a graph of a perfusate oxygen content, as the perfusate flows in and out of rodent hind limbs during preservation.

FIG. 10 shows a graph of oxygen uptake by rodent hind limbs during perfusion preservation.

FIG. 11 shows a perspective view of a first example of a tissue compartment configured for use with the example of FIG. 1.

FIG. 12 shows a perspective view of a second example of a tissue compartment configured for use with the example of FIG. 1.

FIG. 13 shows a perspective view of a third example of a tissue compartment configured for use with the example of FIG. 1.

FIG. 14 shows a front view of a first example of an oxygenator configured for use with the example of FIG. 1.

FIG. 15 shows a front view of a second example of an oxygenator configured for use with the example of FIG. 1.

FIG. 16 shows a front view of a third example of an oxygenator configured for use with the example of FIG. 1.

FIG. 17 shows a partially exploded view of an example of an apparatus for vascular tissue perfusion according to the present disclosure.

FIGS. 18-20 show schematic views of a fluid oscillator configured for use with the example of FIG. 1.

FIG. 21 shows a perspective view of a compliance element, separated from an apparatus for vascular tissue perfusion.

FIG. 22 shows a side plan view of a compliance element, disposed within the head unit of an apparatus for vascular tissue perfusion.

FIG. 23 shows a side plan view of a bifurcated flow element, coupled to the outflow port of the head unit of an apparatus for vascular tissue perfusion.

FIG. 24 shows a side plan view of an expansion flow element in a contracted state, coupled to the outflow port of the head unit of an apparatus for vascular tissue perfusion.

FIG. 25 shows a side plan view of an expansion flow element in an expanded state, coupled to the outflow port of the head unit of an apparatus for vascular tissue perfusion.

FIG. 26 shows a side plan view of a fluid seal between the tissue compartment and the head unit of an apparatus for vascular tissue perfusion.

FIG. 27 shows a side plan view of an expandable tissue compartment forming part of an apparatus for vascular tissue perfusion.

### DETAILED DESCRIPTION

Tissue can be perfused with oxygen to improve preservation, prior to replantation and transplant operations. However, even when perfusion is applied, the quantity of oxygen available to the perfused tissue may be less than what is desired. To solve this problem, the inventor has discovered that in many of the examples described herein, an oxygenated fluid can be generated and circulated around and through a severed extremity, or an organ, to protect it from lack of oxygen, and other nutrients. As a result, the perfused tissue can be preserved in good condition over a period of time that is much longer than that afforded by conventional devices.

For example, in conventional hollow fiber oxygenators, fluid and oxygen flows are continuous and generated by separate mechanisms. The fluid to be oxygenated is mechanically driven by a pump to flow around the outside surface of the hollow fibers, while oxygen flows passively through the lumen of the hollow fibers after passing through a stepdown pressure regulator. Energy stored in the compressed oxygen is wasted, being allowed to dissipate unused. The energy used to drive fluid around the hollow fibers of the oxygenator is often derived from external sources, such as a battery or wall outlet. Backflow though the oxygenator is prevented by the addition of external valve components, which are not an integral part of the oxygenator or pump mechanism, leading to additional complexity.

Accordingly, there is a need for devices and methods that address these and other shortcomings in existing devices. Various examples of the present disclosure relate generally to devices and methods for preservation and perfusion of vascular tissues, including vascular tissues associated with extremities, such as limbs. Most examples of the present disclosure relate to devices and methods for preserving tissue by perfusion.

Many examples provide a highly portable, inexpensive device into which a severed extremity (or other vascular tissue, such as an organ) can be placed, to retain vitality until the patient is ready for attachment, or reattachment. For patients in need of a limb for transplantation, many examples can maintain the health of donor extremities for an extended period of time, such as the total time needed to separate the limb from the donor, to transport the limb from the donor hospital to the transplant hospital, to match the limb to the recipient, to reattach the limb to the recipient, and even longer. Accordingly, geographical limitations from which donor extremities can be obtained can be reduced or eliminated through use of the examples disclosed herein. This advancement in perfusion technology can be valuable to the military, as well as the civilian population, particularly in the face of traumatic avulsion.

In the examples described herein, oxygen permeable capillaries (more generally known as conduits in the description that follows) of an oxygenator, in combination with a pumping membrane, which may comprise a conical pumping membrane, are integrated to achieve three functions in parallel. The first function is to drive perfusate though the attached limb or other vascular tissue. The second function is to prevent retrograde flow of perfusion fluid though the oxygen permeable capillaries of the oxygenator. The third function is to oxygenate the perfusate. In most examples, all three functions may be executed substantially simultaneously, which means that at some point in time, all three functions occur together. Additional discussion of the features that provide these functions follows below.

Many examples can harvest the energy stored in compressed oxygen, as it expands to reach ambient pressure (e.g., as it exits a pressure regulator used to control the oxygen pressure at the exit port). This harvested energy can be used to circulate the preservation perfusate. For example, the combination of the oxygenator and pumping mechanism with an electronically driven microfluidic valve (or a pneumatically-driven fluidics, monostable logic gate operating in a pulsatile fashion) can be used to harvest the energy from the compressed oxygen. The ability to harvest such energy (as well as other design features) permits most examples to provide metabolic support to avulsed limbs for extended periods of time—potentially much longer than existing devices, which are usually only effective for twelve hours, or less.

During operation, various examples operate to direct preservation fluid flow through the lumens of oxygen-permeable capillaries while bathing the exterior of the capillaries with oxygen. Accordingly, the greater surface area of the exterior of the capillaries relative to the interior surface area of those same capillaries provides an oxygenation advantage over conventional devices where the interior of the capillaries is used to transport oxygen, while the exterior of the capillaries is used to transport fluid. Thus, in various examples, the smaller cross-section of the fluid column passing through the oxygen permeable capillaries results in a shorter diffusion path with the advantage of providing a greater amount of oxygen to the fluid in a shorter length of time (when compared to conventional devices). Using a pulsatile flow through the oxygenator increases the oxygenation advantage by allowing the fluid to remain in the capillaries for a longer period of time, increasing the available oxygen diffusion time.

Some examples include a pumping membrane with a conical or inverted funnel shape. A pumping membrane with a conical shape can also act as a bubble trap (i.e., a pumping membrane and bubble trap as a single element), to reduce gas embolization in the attached tissue. Additionally, the pumping membrane can be formed from an oxygen permeable material in certain examples. This can provide additional oxygenation capacity to the perfusion fluid. For example, a pumping membrane having oxygen permeability characteristics can allow additional oxygen to diffuse into the perfusate and increase the dissolved oxygen content of the perfusing fluid. This can in turn deliver more oxygen to the tissue and provide metabolic support for a larger mass of tissue (as compared to a membrane without oxygen permeability characteristics).

Optionally, in this example or in any of the examples disclosed herein, the oxygenator configuration described above provides a compact form factor with a relatively high ratio of the surface area of the oxygenating membrane to the volume of perfusate being oxygenated at a given instant. In many examples, this ratio ranges from 100:1 to 300:1. In addition, the inherent compliance of a base portion of the device housing can enhance recirculation of the perfusate and eliminate the need for a compliant tissue canister. This can provide for a robust canister design that can provide protection to the tissue contained within. Specific examples may be made of biodegradable materials and may be disposable in certain cases.

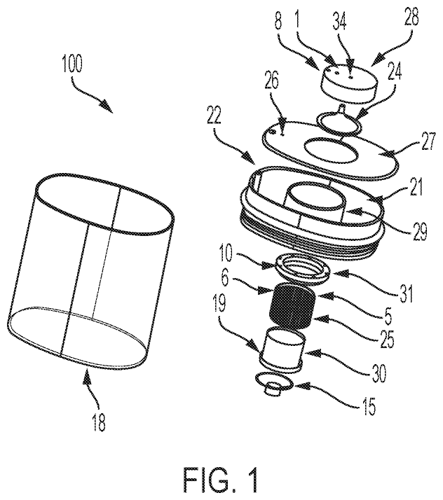

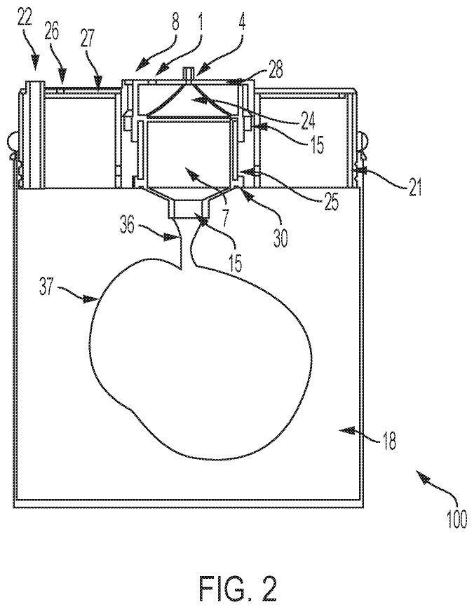

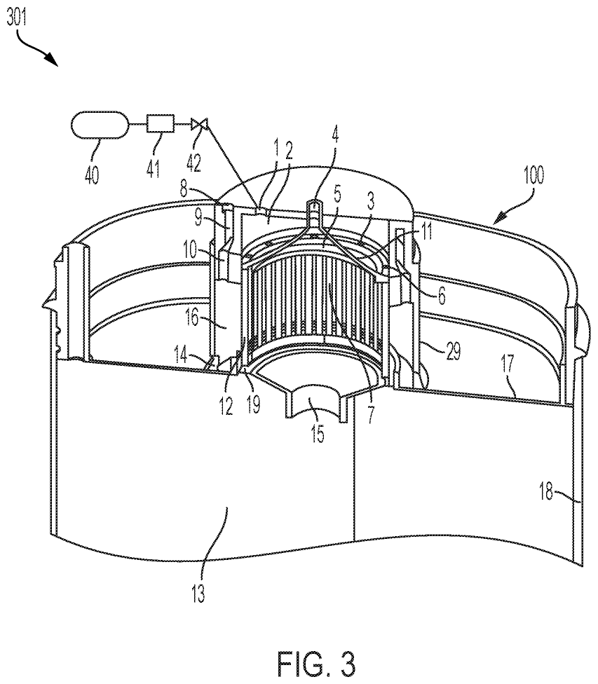

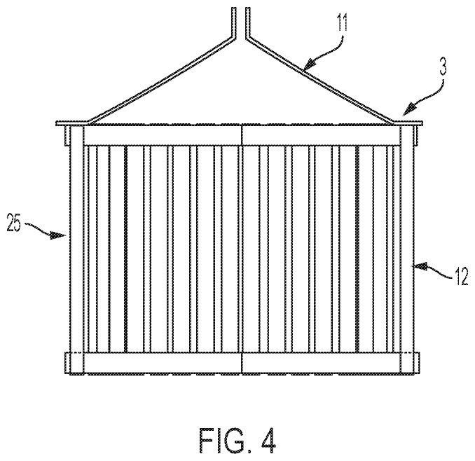

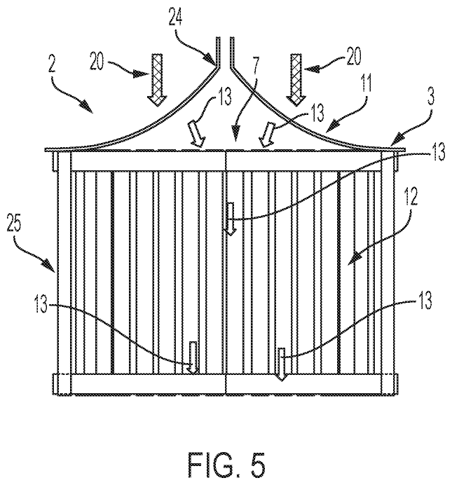

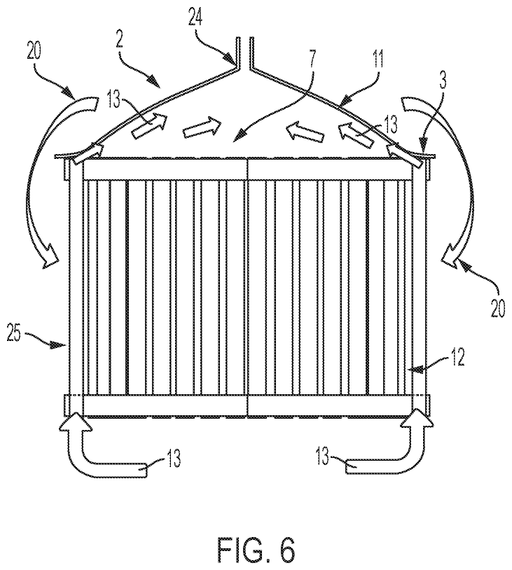

Thus, most examples include devices and methods for vascular tissue perfusion. Referring initially to FIG. 1, an exploded view is shown of an apparatus 100 for vascular tissue perfusion. Apparatus 100 is also shown in a partial section view in FIG. 2, while FIG. 3 illustrates a system 301 and a perspective partial section view of the apparatus 100. FIGS. 4-6 illustrate specific components in different positions and fluid flow during operation of apparatus 100. In particular, FIG. 4 illustrates the components before pressurization, FIG. 5 illustrates the components during pressurization, and FIG. 6 illustrates the components during the diastolic (de-pressurization) phase.

An overview of apparatus 100 and its operation will now be provided, followed by more detailed discussion of various aspects. For purposes of clarity, not all components are labeled with reference numbers in every figure.

Apparatus 100 comprises a tissue compartment 18, a housing 21 (with a lid 27, a fill port 22 and a central channel 29), an oxygenator 25 (with conduits 12 and orifice plate 5 with plate orifices 6), and a pumping diaphragm 24 (with a purge port 4 and a flange 3). In addition, the apparatus 100 comprises a pump chamber cap 28 with a vent port 8, a gas supply port 1, and an outlet 34 aligned with a purge port 4. The apparatus 100 further comprises an oxygenator retaining ring 31 with ring orifices 10, and an oxygenator support 30 with support orifices 19. These components can be assembled as shown in the section views of FIGS. 2 and 3.

Prior to operation of the apparatus 100, an arterial vessel 36 of vascular tissue 37 may be coupled to an outflow channel or port 15. In certain examples, vascular tissue 37 may be part of a severed extremity or limb or organ that is contained within the tissue compartment 18. Optionally, in this example or in any of the examples disclosed herein, a venous vessel of the tissue is left free (e.g., not coupled to channel 15 or any other port) to discharge fluid into the compartment 18. In preparation for operation of the apparatus 100, compartment 18 can be partially filled with preservation solution 13, and housing 21 can be inserted into compartment 18, partially submerging the vascular tissue 37 to be perfused. In certain examples, compartment 18 can be of sufficient size and volume to accept an entire human leg or arm, or reduced in size to accept a variety of smaller vascular tissues. In most examples, preservation or perfusion solution comprises Belzer MPS® solution, University of Wisconsin solution, Celsior solution, or any crystalloid solution.

Additional preservation solution 13 can be added through fill port 22, filling compartment 18 and completely submerging the vascular tissue 37. Preservation fluid 13 can continue to flow up through conduits 12 of the oxygenator 25, filling a channel 7 (e.g., a volume located in the interior region of the oxygenator support 30, between pumping diaphragm 24 and outflow channel 15). Preservation fluid 13 is permitted to exit the purge port 4 of pumping diaphragm 24. The fill port 22 and purge port 4 can then be closed, and chamber 2 can be pressurized with oxygen, perhaps using intermittent pulses delivered through the gas supply port 1, as explained further below.

During operation of the apparatus 100, oxygen 20 at higher pressure (e.g., a pressure that is higher than the ambient pressure surrounding the apparatus 100) enters chamber 2 to exert a force on pumping diaphragm 24, resulting in a downward deflection of surface 11 of diaphragm 24, moving the surface 11 closer to the oxygenator 25, as shown in FIG. 5. The upper ends of conduits 12 (e.g. the ends proximal to flange 3 of diaphragm 24) of the oxygenator 25 are occluded by flange 3 and the pressure within the chamber 2 increases. The deflection of surface 11 forces preservation fluid 13 from channel 7 down through outflow channel 15 (shown in FIG. 3) and into the arterial vessel 36 of the vascular tissue 37 coupled to outflow channel 15.

Optionally, in this example or in any of the examples disclosed herein, a control system 41 with a valve 42 can be used to control a source 40 of pressurized oxygen that is pulsed through chamber orifice 1 into chamber 2 to generate the increased pressure within the chamber 2. In certain examples valve 42 may comprise a pneumatic valve, and control system 41 may comprise an electronic circuit that controls valve 42. For example, control system 41 can open valve 42 to admit oxygen through port 1 into chamber 2, and then close valve 42 to allow oxygen from chamber 2 to exhaust through port 8.

Particular examples may include a fluidic configuration, described in more detail with respect to FIGS. 18-20 below, in which oxygen exits the source 40 of pressurized oxygen into port 1, pressurizing chamber 2. When the pressure in pumping chamber 2 exceeds a preset pressure, feedback diverts oxygen flow from port 1 to exhaust port 8.

As previously noted, the increased oxygen pressure holds flange 3 of pumping diaphragm 24 securely against orifice plate 5, occluding plate orifices 6 at the upper ends of conduits 12, to prevent back flow. Substantially simultaneously, oxygen 20 can diffuse through surface 11 (which is optionally oxygen permeable in this example or in any of the examples disclosed herein) to oxygenate the preservation fluid 13 in channel 7.

After perfusing the vascular tissue 37, preservation fluid 13 exits the venous vessel, or otherwise passes through the mass of vascular tissue 37, to travel into the compartment 18. Housing 21 includes a base plate 17 that flexes upward (e.g., away from the vascular tissue coupled to outflow channel 15) to accommodate the increased volume of preservation solution 13 flowing into compartment 18. Between the occasions when pulses of higher pressure enter the chamber 2, the pressure in chamber 2 is reduced by venting oxygen through vent orifice 8 into chamber 9, and through ring orifices 10 of ring 31 into vent chamber 16. Allowing oxygen 20 in chamber 2 to vent in this manner also allows oxygen 20 to pass around conduits 12 as shown in FIG. 6. This can remove carbon dioxide and oxygenate the preservation solution within conduits 12. The oxygen 20 in vent chamber 16 can flow through housing orifice 14 into housing 21 and exhaust through the exhaust port 26 in housing lid 27 to the atmosphere surrounding the apparatus 100.

The recoil of the base plate 17 (e.g. downward from its previous upward deflection toward vascular tissue coupled to outflow channel 15) reduces the effective volume of compartment 18 and forces preservation solution 13 up through the oxygenator orifices 19 and conduits 12 of oxygenator 25. The pressure gradient between the vascular tissue storage compartment 18 and chamber 2 causes the preservation solution 13 to lift the pumping membrane flange 3, so as to accumulate in channel 7, as shown in FIG. 6. This activity displaces the oxygenated solution from conduits 12, into channel 7, in preparation for the next cycle. The cycle repeats as oxygen is pulsed through chamber orifice 1 into chamber 2 at the higher pressure (i.e., than the ambient pressure surrounding the apparatus 100).

The means by which pressure is delivered to chamber orifice 1 may comprise a microfluidic valve controlled by electronic circuitry to produce a pulsatile pattern. Other examples may employ a fluidics monostable logic gate such as an OR gate or an OR/NOR gate. Both devices can have internal channels for directing exhaust oxygen to orifice 8. An example of this example is described in more detail with respect to FIGS. 18-20, below.

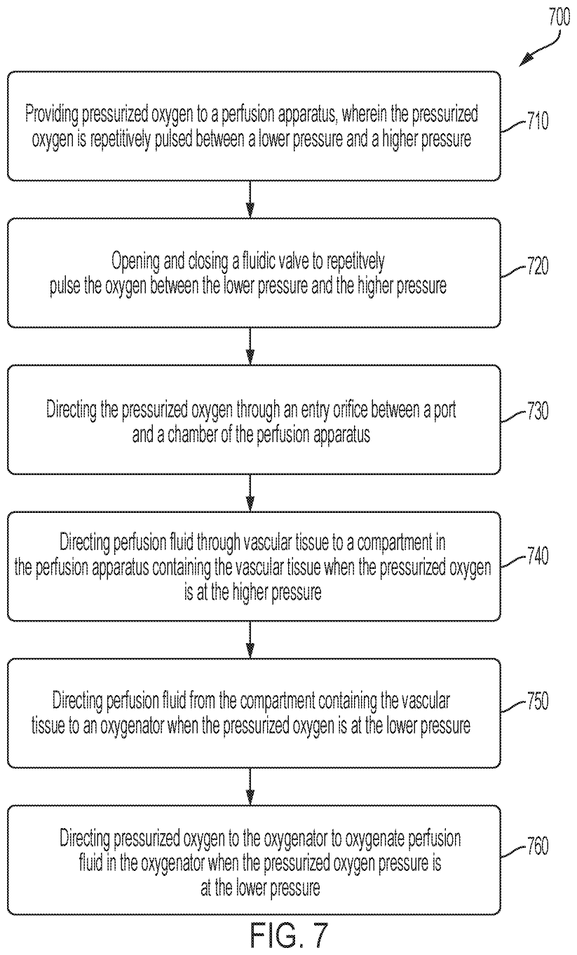

Referring now to FIG. 7, a flow diagram 700 is shown illustrating actions 710-760 performed in various methods according to the present disclosure. It is understood the actions do not necessarily need to be performed in the sequential order presented in flow diagram 700 in all examples. Action 710 comprises providing pressurized oxygen to a perfusion apparatus, wherein the pressurized oxygen is repetitively pulsed between a lower pressure and a higher pressure. Action 720 comprises opening and closing a microfluidic valve to repetitively pulse the oxygen between the lower pressure and the higher pressure, while action 730 comprises directing the pressurized oxygen through an entry orifice between a port and a chamber of the perfusion apparatus. Action 740 comprises directing perfusion fluid through vascular tissue to a compartment in the perfusion apparatus containing the vascular tissue when the pressurized oxygen is at the higher pressure, and action 750 comprises directing perfusion fluid from the compartment containing the vascular tissue to an oxygenator when the pressurized oxygen is at the lower pressure. Action 760 comprises directing pressurized oxygen to the oxygenator to oxygenate perfusion fluid in the oxygenator when the pressurized oxygen pressure is at the lower pressure.

As disclosed herein, various examples of the present disclosure include an apparatus for vascular tissue perfusion. In certain examples, the apparatus comprises: an oxygenator comprising a first end, a second end, and a plurality of conduits extending from the first end to the second end; and a flexible membrane comprising a first side and a second side. In particular examples, the first side of the flexible membrane is proximal to the first end of the oxygenator; the flexible membrane is configured to restrict fluid flow through the plurality of conduits when the second side of the flexible membrane is subjected to a higher pressure than the first side of the flexible membrane; and the flexible membrane is configured to allow fluid flow through the plurality of conduits when the first side of the flexible membrane is subjected to a higher pressure than the second side of the flexible membrane.

In specific examples, the flexible membrane is conical shaped. In certain examples, the first end comprises a port and the second end comprises a flange. In particular examples, the flange of the flexible membrane is configured to deflect away from the first end of the oxygenator when the first side of the flexible membrane is subjected to a higher pressure than the second side of the flexible membrane. Optionally, in this example or in any of the examples disclosed herein, the flexible membrane is oxygen permeable. In specific examples, the flexible membrane comprises a tapered portion having a first end and a second end, and the first end has a smaller cross-sectional area than the second end.

In various examples, capillaries, conduits, membranes, and surfaces comprise oxygen permeable materials. Such materials include silicone, polyethylene, and any other oxygen-permeable material.

Certain examples further comprise a central channel, where the plurality of conduits are located around the central channel, and where the flexible membrane is configured to force fluid flow through the central channel when the second side of the flexible membrane is subjected to a higher pressure than the first side of the flexible membrane. Particular examples further comprise a chamber extending the central channel, where the plurality of conduits are located within the chamber. Optionally, in this example or in any of the examples disclosed herein, the chamber is in fluid communication with a source of pressurized oxygen.

Specific examples further comprise a compartment configured to contain vascular tissue, where the central channel of the oxygenator is in fluid communication with the compartment configured to contain vascular tissue, and where the compartment comprises an opening to an interior volume of the compartment. Certain examples further comprise a housing coupled to the opening of the compartment, where the housing comprises a flexible base plate proximal to the interior volume of the compartment.

In particular examples, the flexible base plate is configured to flex away from the interior volume of the compartment when the second side of the flexible membrane is subjected to a higher pressure than the first side of the flexible membrane. Some examples further comprise an outflow port coupled to the central channel of the oxygenator, where the outflow port is in fluid communication with the interior volume of the compartment. Specific examples further comprise vascular tissue, where the vascular tissue is located in the compartment. In certain examples, the vascular tissue comprises an arterial vessel coupled to the outflow port. Particular examples further comprise a tissue preservation solution in the compartment, the central channel of the oxygenator, and the plurality of conduits of the oxygenator. In particular examples, the vascular tissue comprises a limb, or an organ. Some examples further comprise a control system configured to pulse the higher pressure to the first side of the flexible member. In specific examples, the control system comprises a microfluidic valve.

Certain examples include a method of vascular tissue perfusion, where the method comprises: providing pressurized oxygen to a perfusion apparatus, wherein the pressurized oxygen is repetitively pulsed between a lower pressure and a higher pressure; directing perfusion fluid through vascular tissue to a compartment in the perfusion apparatus containing the vascular tissue when the pressurized oxygen is at the higher pressure; directing perfusion fluid from the compartment containing the vascular tissue to an oxygenator when the pressurized oxygen is at the lower pressure; and directing pressurized oxygen to the oxygenator to oxygenate perfusion fluid in the oxygenator when the pressurized oxygen pressure is at the lower pressure.

In particular examples of the method, the perfusion device comprises a chamber in fluid communication with a port and an exhaust orifice, the oxygenator comprises a plurality of conduits comprising the perfusion fluid, the plurality of conduits are located within the chamber, and directing the pressurized oxygen to the oxygenator comprises directing the pressurized oxygen through the port, into the chamber, and out of the exhaust orifice. Specific examples of the method further comprise directing the pressurized oxygen through an entry orifice between the port and the chamber. In certain examples of the method, directing the perfusion fluid through vascular tissue comprises deflecting a flexible membrane when the pressurized oxygen is at the higher pressure. In particular examples of the method, the flexible membrane operates to direct fluid through a channel extending through a central portion of the oxygenator when the pressurized oxygen is at the higher pressure.

In specific examples of the method, a volume of the compartment containing the vascular tissue expands when perfusion fluid flows from the vascular tissue to the compartment containing the vascular tissue. In certain examples of the method, the volume of the compartment containing the vascular tissue contracts when the pressurized oxygen is at the lower pressure. In particular examples of the method, a flexible plate flexes to expand the volume of the compartment containing the vascular tissue, and in specific examples of the method the flexible plate flexes to contract the volume of the compartment containing the vascular tissue. In certain examples of the method, perfusion fluid is directed from the compartment containing the vascular tissue to the oxygenator when the flexible plate flexes. In certain examples, the pressurized oxygen is repetitively pulsed between the lower pressure and the higher pressure by opening and closing a microfluidic valve.

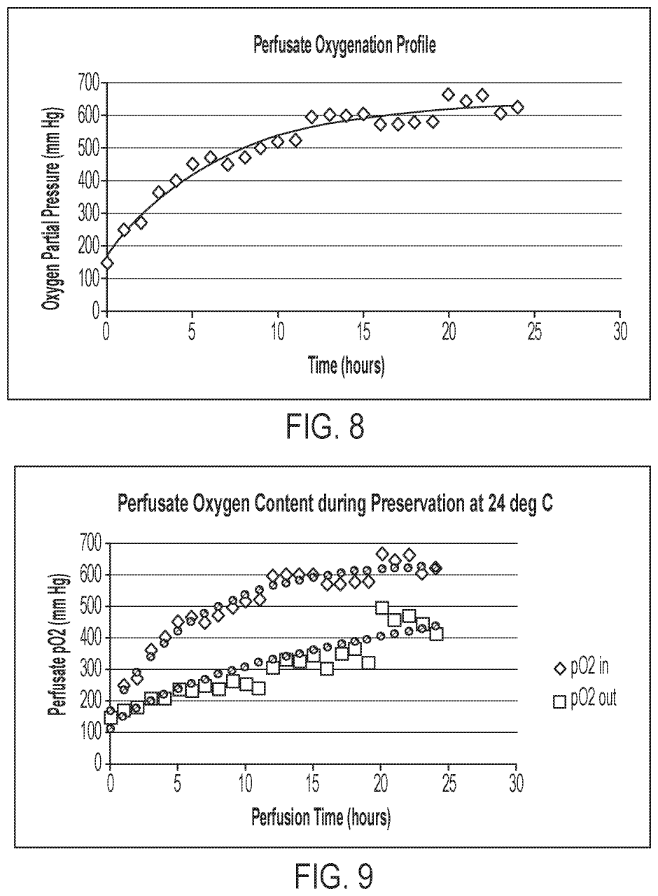

FIGS. 8-10 include graphs that illustrate perfusate oxygenation data and oxygen uptake during perfusion preservation utilizing apparatus and methods according to the present disclosure. In particular, FIG. 8 shows a graph of a perfusate oxygenation profile illustrating oxygen partial pressure over time at 24 degrees Celsius. As shown in FIG. 8, the oxygen partial pressure is initially between 100 and 200 mm Hg and increases to a level between 600 and 700 mmHg over a period of approximately 24 hours.

FIG. 9 shows a graph of a perfusate oxygen content into and out of rodent hind limbs during perfusion preservation over time at 24 degrees Celsius. The perfusate oxygen content of the perfusate flowing into the limbs (represented by diamonds in the graph) begins at a level between 150 and 200 mm Hg and increases to a level between 600 and 700 mmHg over a period of approximately 24 hours. The perfusate oxygen content of the perfusate flowing out of the limbs (represented by squares) begins at a level slightly above 100 mm Hg and increases to a level between 400 and 500 mmHg The difference in the oxygen levels into and out of the limbs represents oxygen extraction by limb tissue.

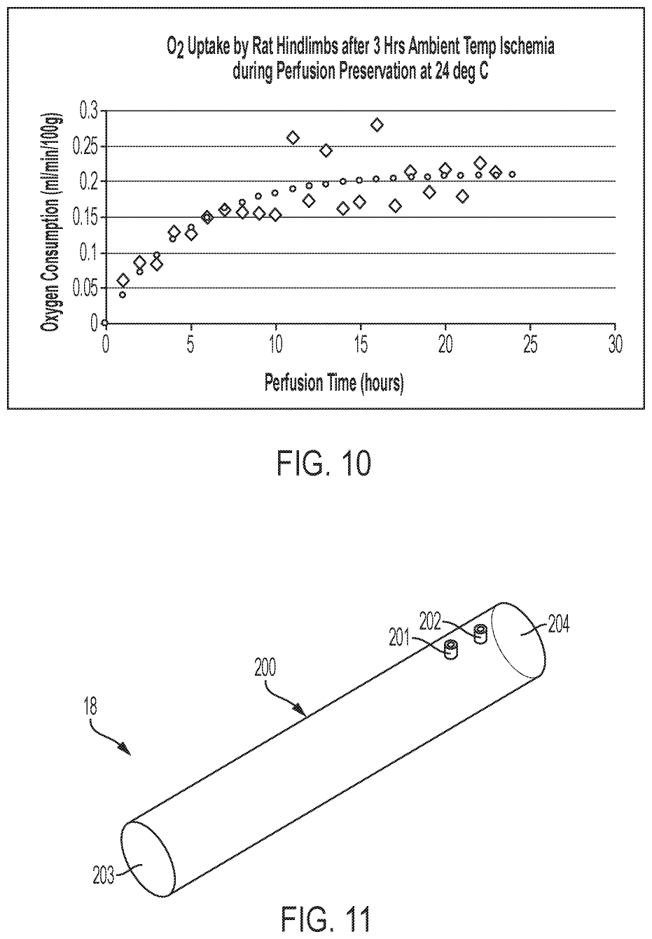

FIG. 10 shows a graph of oxygen uptake by rodent hind limbs during preservation over time at 24 degrees Celsius (after three hours of ambient temperature ischemia). As shown in FIG. 10, the oxygen uptake or consumption increases from zero to approximately 0.21 ml/min/100 g over a period of approximately 24 hours.

Referring now to FIG. 11, a tissue compartment 18 may be fabricated as a sleeve 200 from a clear or colored flexible material such as polyvinyl chloride polymer (PVC) having a diameter and length that is sufficient to accommodate the entire length of vascularized tissue, such as an appendage (e.g., human hand, arm, or leg) or organ. Along the length of the sleeve 200 there may be disposed two ports 201 and 202. One port 201 can be used to fill the sleeve 200 with preservation solution, and the second port 202 can be used to provide venting of air during fluid filling via the port 201. After filling is complete, the ports 201, 202 can be capped off or otherwise sealed to retain the preservation solution in the sleeve 200 during transport. One end 203 of the flexible sleeve 200 is open so as to enable fluid communication with the apparatus 100, while the other end 204 may have one of three configurations, among others.

In a first configuration, the other end 204 of the sleeve 200 may be sealed in a fluid-tight fashion, perhaps by gluing, clamping, plastic welding or heat-sealing, or perhaps by fusion with a piece of the same material, or a different material, as that which makes up the rest of the sleeve 200. This first configuration may be useful in preserving an avulsed appendage by measuring the length of the appendage and then trimming the sleeve 200 proximate to the open end 203 so as to accommodate the entire length of the appendage and the outer circumference of the rim of the housing 21 of apparatus 100. In a particular example, sleeve 200 of compartment 18 can be cut to a desired length in the field using hand operated tools (e.g. scissors or a knife). Preservation solution can then be infused through port 201 using port 202 as a vent—both ports 201, 202 being located along the length of sleeve 200.

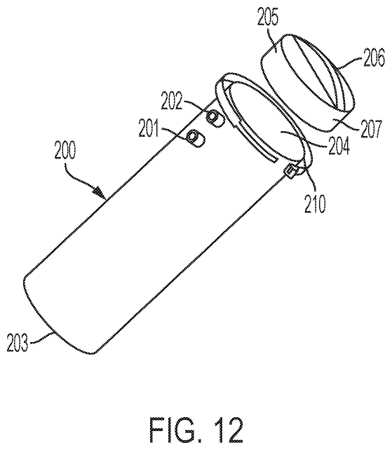

A second configuration, as shown in FIG. 12, may comprise a hard plastic insert 205 with an outside diameter approximately the same as the inside diameter of the sleeve 200. The plastic insert 205 may have a flat or curved surface 206 with a circumferential rim 207 so as to provide a surface for attaching the sleeve 200 to the rim 207 with a clamp or zip strap 210 to make a fluid-tight seal. This second configuration may be useful in preserving an avulsed appendage by trimming the sleeve 200 from the open end 203 so as to accommodate the entire length of the appendage 300, permitting attachment of one end 203 the sleeve 200 to the rim of the housing 21 of the apparatus 100, and attachment of the other end 204 of the sleeve 200 to the rim 207 of the plastic insert 205. Preservation solution can then be infused through port 201 using port 202 as a vent—both ports 201, 202 located along the length of sleeve 200.

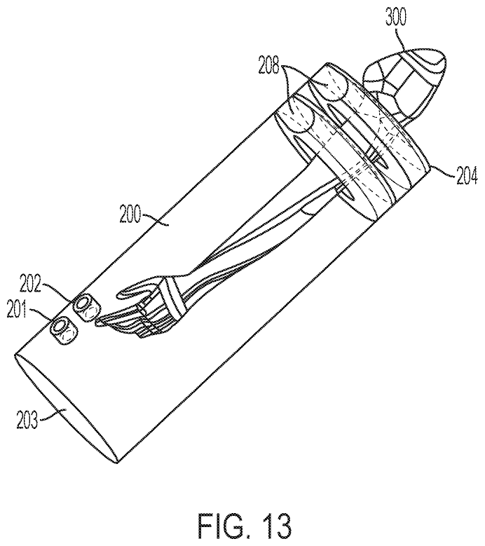

A third configuration, as shown in FIG. 13, may be used to preserve an appendage that is still attached to a human body. In the configuration of FIG. 13, the sleeve 200 is shown to have one or more flexible seals, such as flexible cuffs 208 located proximate to the end 204 of the sleeve 200, such that when the appendage 300 is inserted into the aperture in the cuffs 208, the cuffs 208 can then be enlarged and tightened against the skin of the appendage 300, perhaps by expansion (e.g., an expanding chemical composition inside the cuffs 208, or inflation with air or a gas), to create a fluid-tight interface between the cuffs 208 and the skin of the appendage 300. If the cuffs 208 are inflated or otherwise enlarged to provide sufficient pressure against the skin of the appendage 300, the cuffs 208 can act as a primary tourniquet or a secondary tourniquet (e.g., when a conventional tourniquet is also applied to the appendage 300 as the primary tourniquet). In this third configuration, the sleeve 200 is deployed by sliding the end 204 with the cuffs 208 over the appendage 300 as far as possible, up to the level of a primary tourniquet, if one has been applied. The cuff or cuffs 208 are then inflated so as to create a fluid-tight seal against the skin of the appendage 300 and/or to provide a tourniquet effect, as needed. The other end 203 of the sleeve 200 is trimmed to a length that will accommodate the length of the appendage 300 and the rim of housing 21 of apparatus 100. The sleeve 200 can then be filled with preservation solution through port 201, using port 202 as a vent for circulation by apparatus 100.

Referring now to FIG. 14, the oxygenator 25 may comprise a plurality of conduits 12 having a length that is longer than necessary to traverse the distance from the first end 400 of the oxygenator 25, to the second end 401 of the oxygenator 25. In this example, the conduits 12 are sufficiently long to bow outward, away from an axis that runs through the center of each of the ends 400, 401, the conduits 12 forming a convex curve with a radius sufficient to displace the midpoint of the conduits 12 a selected distance from the outer surface of the oxygenator support 30. Optionally, in this example or in any of the examples disclosed herein, this selected distance is about 2 mm to about 25 mm

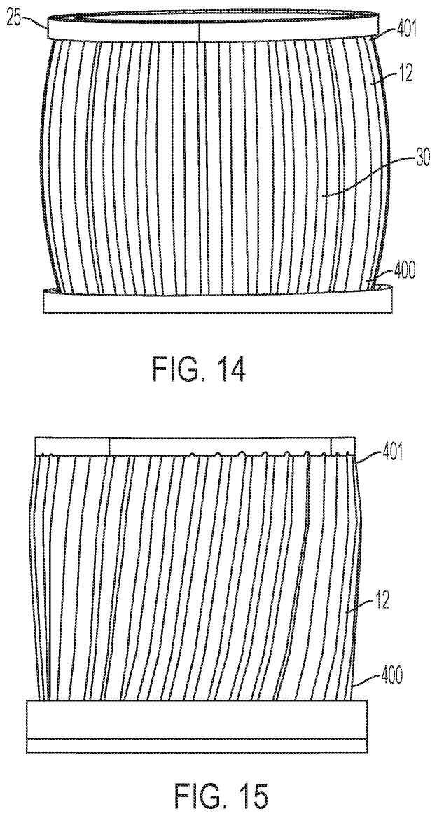

Optionally, in this example or in any of the examples disclosed herein, as shown in FIG. 15, the first end 400 of the oxygenator 25 may be rotated clockwise or counter-clockwise by about 5 to 60 degrees relative to the second end 401 of the oxygenator 25 such that the conduits 12 are not linear (e.g. the conduits are curved or angled when viewed from the side of oxygenator 25, as shown in FIG. 15). Both variations, whether comprising distended conduits 12 as shown in FIG. 14, or angled conduits 12 as shown in FIG. 15, separately or in combination, may take advantage of Coriolis forces when the apparatus 100 is operating, to induce a swirling of the perfusate as it flows through the conduits 12 to enhance perfusate oxygenation. Installation of the conduits 12 in an oxygenator 25 that is used in the northern hemisphere of the Earth can have the first end 400 rotated counter-clockwise relative to second end 401 (when viewed from second end 401), whereas an oxygenator 25 which is used in the southern hemisphere of the Earth may have the first end 400 rotated clockwise relative to the second end 401. Optionally, in this example or in any of the examples disclosed herein, the same oxygenator 25 can be used in each instance, by simply inverting it within the housing 21, as the apparatus 100 is moved to a different hemisphere.

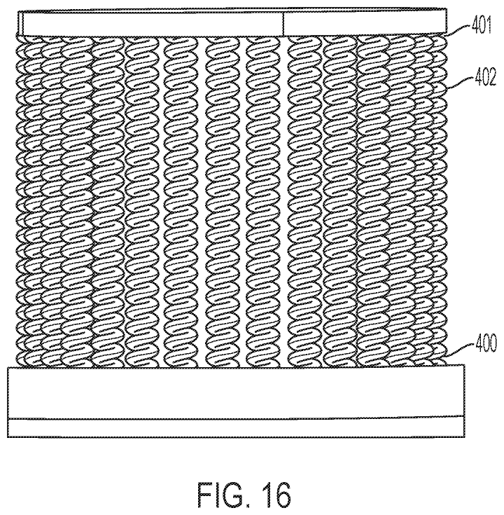

As shown in FIG. 16, conduits 12 may optionally, in this example or in any of the examples disclosed herein be formed as helical conduits 402. The spirals of the helical conduits 402 may be formed in either a clockwise or counter-clockwise direction (when viewed from second end 402), and have a radius of curvature which precludes kinking of the inner surfaces of the helical conduits 402. The helical conduits 402 may be deployed in any of the preceding examples described herein.

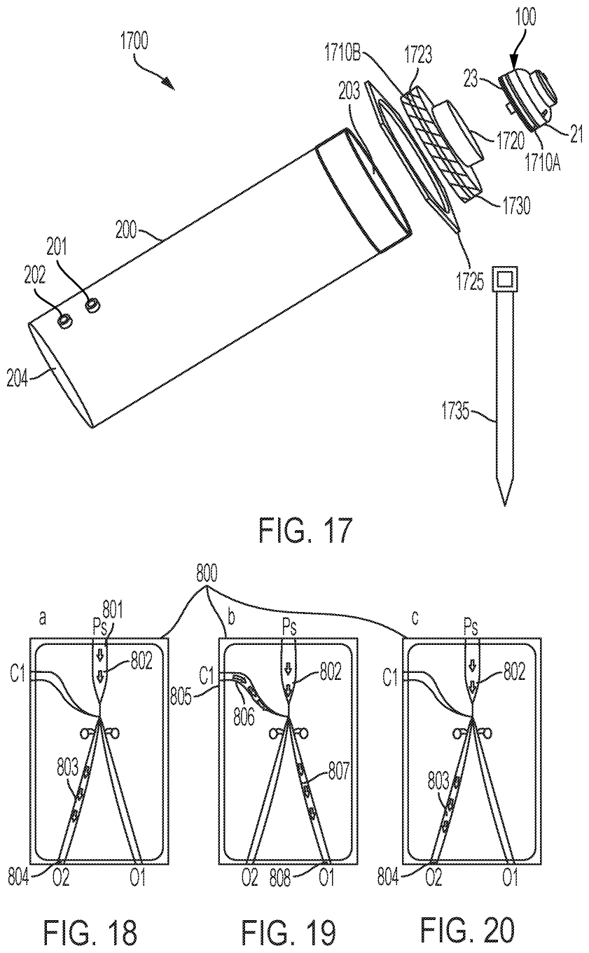

While FIG. 11 illustrates how appendages of various lengths can be accommodated, using a sleeve 200 that can be cut to size, FIG. 17 illustrates the capability of the apparatus 100 to easily adapt to appendages with larger or smaller diameters.

In one example, as shown in configuration 1700, the housing 21 of apparatus 100 may be fabricated in a circular fashion (instead of an oval, as shown in FIG. 1). Optionally, in this example or in any of the examples disclosed herein, the end 203 of the sleeve 200 may be fabricated from two materials: one material that is more compliant than the other end of the sleeve 200. For example, the end 203 of the sleeve 200 may be fabricated from a thinner polyethylene or silicone material, while the other end 204 of the sleeve 200 may be fabricated from a thicker polyethylene material, the two materials being fused together into a single, continuous, fluid-tight, open-ended sleeve 200.

Optionally, in this example or in any of the examples disclosed herein, the housing 21 may have engagement means 1710A to directly couple to the sleeve 200 to provide a fluid-tight seal at the end 203. For example, the engagement means may comprise coarse threads, and a large nut 1725 with corresponding coarse threads may be screwed onto the housing threads, with a circumferential portion of the sleeve 200 at end 203 captured between the two engaging components, to form a fluid-tight seal. Optionally, in this example or in any of the examples disclosed herein, the engagement means 1710A may comprise a channel cut into the circumference of the housing 21, and a clamp or zip strap 1735 may be applied around the circumference of the housing 21 (e.g., in a similar manner to what is shown for the insert 205), compressing a circumferential portion of the sleeve 200 against the housing 21, with or without a channel, again, to form a fluid-tight seal.

Optionally, in this example or in any of the examples disclosed herein, the housing 21 may have engagement means 1710A such as threads, clasps, snap-locks, or twist locks which can be engaged with the surface 1720 of an interface plate extension 1730. The surface 1720 may thus comprise corresponding engagement means, to engage the engagement means 1710A of the housing 21, to provide a fluid-tight seal. In this way, the interface plate extension 1730 also serves to enlarge the area of the base plate 17 (as shown in FIG. 1), so as to accommodate appendages of different diameters. If the base plate extension 1730 is used, then the end 203 of the sleeve 200 would be engaged directly with the outer diameter OD 1723 of the base plate extension 1730, using similar or identical engagement means 1710B, such as a channel, threads, clasps, snap-locks, or twist locks attached to the OD 1723 to provide a fluid-tight seal—in a manner identical to, or similar to the examples described with respect to how the end 203 of the sleeve 200 can be engaged directly with the housing 21, or the engagement means 1710A of the housing 21 (when the base plate extension 1730 is not used).

For example, if the appendage comprises an arm, the base plate extension 1730 might have an outer diameter OD of approximately 10 cm to 20 cm. If the apparatus 100 is used to sustain a leg, the outer diameter OD of the base plate extension 1730 might be approximately 15 cm to 40 cm. In this manner, a housing 21 having, for example, a fixed inner diameter ID 23 of approximately 3 cm-15 cm (or any inner diameter ID that is less than the outer diameter OD 1723 of the base plate extension) can be engaged with a base plate extension 1730, enlarging the effective inner diameter ID of the housing 21 to be any desired size, as defined by the outer diameter OD.

While a circular housing 21 is shown in the figure, other geometric shapes (e.g., square, oval, rectangle, triangle) that make use of fluid-tight engagement means 1710A between the housing 21 and the surface 1720 of the base plate extension 1730 can be used. These include a snap-lock arrangement, where the housing 21 snaps into the base plate extension 1730 to form a fluid-tight seal, perhaps with the aid of a flexible gasket (not shown). The base plate extension 1730 can be attached to the sleeve 200 in a number of ways, as described previously.

Referring now to FIG. 3, it can be seen that a control system 41 with a valve 42 can be used to control a source 40 of pressurized oxygen that is pulsed through chamber orifice 1 into pumping chamber 2 to generate the increased pressure within the chamber 2. In certain examples valve 42 may comprise a pneumatic valve such as a Parker X-valve #912-000001-031, and control system 41 may comprise an electronic circuit that provides intermittent electrical pulses that controls valve 42. For example, control system 41 can generate an electrical pulse to open valve 42 to admit oxygen through port 1 into chamber 2, and then terminate the electrical pulse to close valve 42 to allow oxygen from chamber 2 to exhaust through port 8.

Referring now to FIGS. 1-6 and 18-20, it can be seen that some examples may include a fluidic oscillator 800, in which oxygen 20 exits the source 40 of pressurized oxygen into port 801 of the oscillator 800. In this example, the fluidic oscillator is used in place of the control system 41 and valve 42 of FIG. 2, so that a direct fluid path exists between the source 40, the oscillator 800, and the pressurizing chamber 2.

In this example, as shown in FIG. 18, oxygen 20 flows from the source 40, through channel 802, and by virtue of the Coanda Effect follows channel 803 to exit exhaust port 804.

This action pressurizes the pumping chamber 2, because the exhaust port 804 is coupled directly to the pumping chamber 2.

Referring now to FIG. 19, when the pressure in pumping chamber 2 rises to the pressure governed by the regulator on the oxygen source 40, feedback flow from the pumping chamber 2, which is coupled to port 805, initiates flow in channel 806. This flow in channel 806 serves to divert the flow of oxygen 20 from channel 803 into channel 807. Oxygen 20 then exits through exhaust port 808 and enters port 808, which is coupled directly to chamber 16—where it exists to the atmosphere through port 14.

Referring now to FIG. 20, when the pumping chamber 2 is vented via port 14, flow through port 805 and channel 806 ceases, causing the flow of oxygen 20 to return to channel 803, repeating the cycle. In this way, the oscillator 800 acts as a fluidic OR gate, controlled by the feedback flow presented by port 805, so that the flow of oxygen 20, introduced at port 801, oscillates between exhaust ports 804 and 808. The feedback flow can be obtained by coupling port 805 directly to pumping chamber 2.

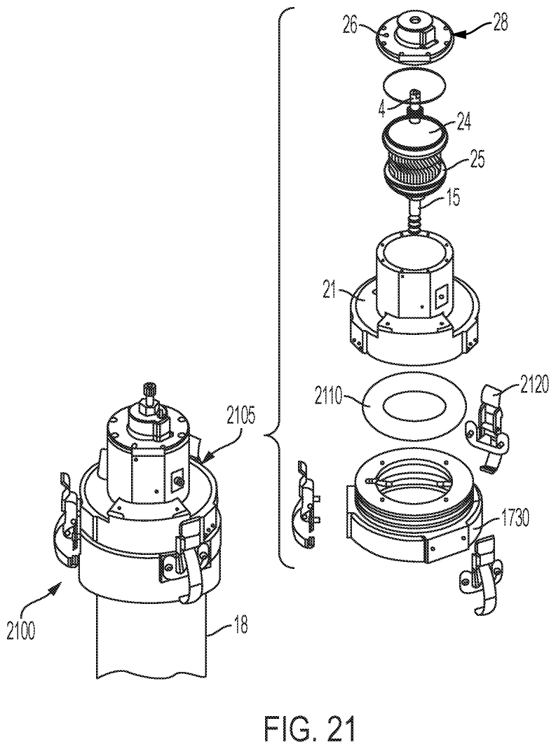

FIG. 21 is a perspective view of a compliance element 2110, separated from an apparatus 2100 for vascular tissue perfusion. Optionally, in this example or in any of the examples disclosed herein, the apparatus 2100, which may be similar to or identical to the apparatus 100 described in any of the figures above, comprises a head unit 2105 and a tissue compartment 18, which can be attached to the head unit 2015, and operates over a pulsatile pressure range inside the tissue compartment 18 of approximately 2 mm Hg to approximately 50 mm Hg. As shown in the figure, the head unit 2105 may be attached to the tissue compartment 18 using a plurality of snap latches.

Optionally, in this example or in any of the examples disclosed herein, a compliance element 2110 is used in conjunction with the apparatus 2100, as a mechanism for providing volumetric compliance to the tissue compartment 18 when the tissue compartment 18 is not itself substantially compliant over the range of pressure changes that are part of regular use for the apparatus 2100. That is, in most examples, while the tissue compartment 18 is substantially rigid, with an internal volume that does not change substantially when subjected to internal pressures over a range of approximately 2 mm Hg to approximately 50 mm Hg, the compliance element 2110 is constructed of a material and/or with a hollow interior and a relatively thin wall, so that the internal volume of the compliance element 2110 does change when subjected to this ranges of pressures on its external surface.

In most examples, the compliance element 2110 comprises a closed shape, which may comprise a spherical shape, a cylindrical shape, an ellipsoidal shape, a toroidal shape (as shown in the figure), a cubic shape, a pyramidal shape, or some other shape. The compliance element 2110 may optionally be solid in this example or in any of the examples disclosed herein, or hollow in this example or in any of the examples disclosed herein. When the compliance element 2110 is hollow, its interior may be filled with a gas (for example, oxygen, or nitrogen), or air. The compliance element 2110 may be constructed from one or more materials that include medical grade rubber, polycarbonate, acrylic, and/or polymers, such as Polyethylene Terephthalate (PET), Polytetrafluoroethylene (PTFE), and nylon.

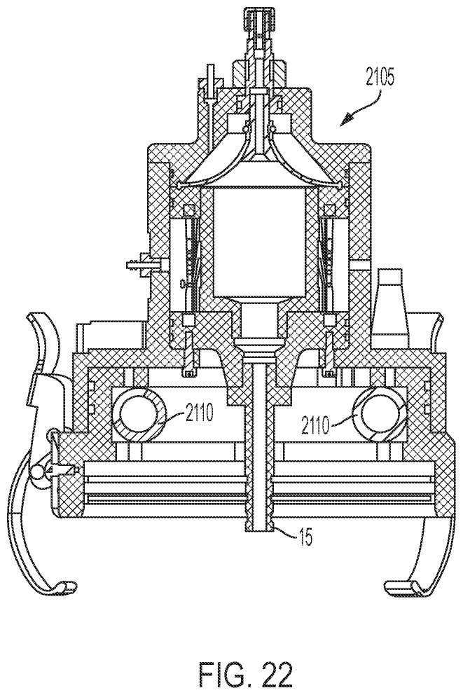

FIG. 22 is a side plan view of a compliance element 2110 disposed within the head unit 2105 an apparatus 2100 for vascular tissue perfusion. The compliance element 2110 may simply be placed within the tissue compartment 18, or disposed within the head unit 2105, around the outflow channel or port 15, as shown in the figure. In any case, the compliance element 2110, when subjected to pressure within the tissue compartment 18 of approximately 2 mm Hg to approximately 50 mm Hg, compresses to some degree, by virtue of a reduced interior volume, to store energy. When the pressure within the tissue compartment 18 is reduced at a later time, the compliance element 2110 will release the stored energy into the perfusion fluid surrounding the vascularized tissue stored in the tissue compartment 18. Essentially, the compliance element 2110 acts as a source of increased internal volume for the tissue container, and facilitates active perfusion, because using the compliance element 2110 allows more fluid to enter the tissue compartment 18 than would occur if the compliance element 2110 were substantially rigid, and non-compliant. The effective spring constant of the compliance element 2110 thus provides energy to facilitate circulation of the perfusion fluid within the tissue compartment 18. Thus, the compliance element, when subjected to an external pressure range of approximately 2 mm Hg to approximately 50 mm Hg, compresses so as to increase the available volume for fluid to circulate within the tissue compartment 18 and the head unit 2105.

Optionally, in this example or in any of the examples disclosed herein, the compliance element 2110 is constructed to be responsive to a selected range of pressures, such as approximately 5 mm Hg to approximately 40 mm Hg, or a frequency of pulsation, such as approximately 60 cycles per second, or 120 cycles per second, or some value in a range of approximately 40 cycles per second to approximately 180 cycles per second. Tuning the response of the compliance element 2110 in this manner can reduce the pressures over which perfusion occurs, since a reduced pulse peak height results in lower perfusion pressures, and a higher frequency of pulsation results in greater fluid flow volume. Tuning can be accomplished by constructing the compliance element 2110 with a selected wall thickness, a selected material property (such as mechanical stiffness, or modulus of elasticity), or a selected interior volume.

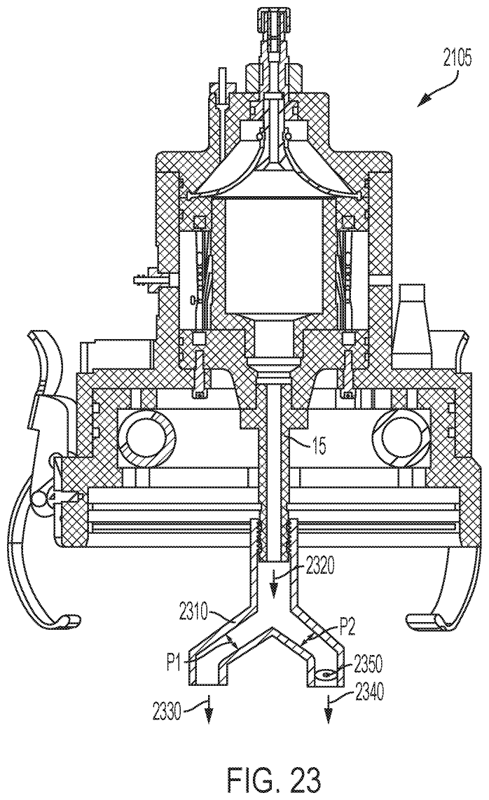

FIG. 23 is a side plan view of a bifurcated flow element 2310 coupled to the outflow port 15 of a head unit 2105 an apparatus for vascular tissue perfusion. When the bifurcated flow element 2310 is used to supply vascularized tissue with perfusion fluid, instead of the single outflow port 15, vascularized tissue with separate circulation systems can be supported by the apparatus. For example, the bifurcated flow element 2310 can be used to divide the flow 2320 of perfusate out of the single outflow port 15 into two flows, 2330 and 2340, perhaps to supply the portal and hepatic circulation systems in a human liver, respectively. Optionally, in this example or in any of the examples disclosed herein, the flows 2330 and 2340 are approximately the same, and optionally, in this example or in any of the examples disclosed herein, the internal passage dimensions P1, P2 of the bifurcated flow element 2310 are of a different size, or contain flow restriction elements 2350, such as a washer, to provide flows 2330 and 2340 that differ from each other in pressure, volume, or velocity.

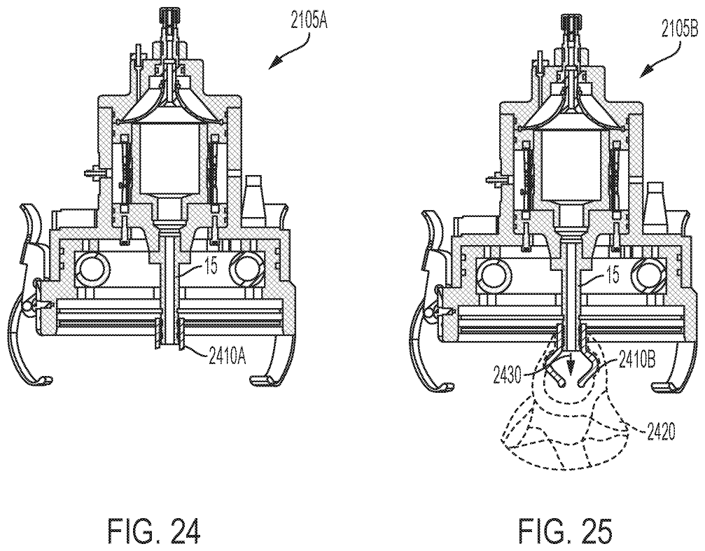

FIGS. 24 and 25 present a pair of side plan views of an expansion flow element 2410 coupled to the outflow port 15 of the head unit 2105 of an apparatus for vascular tissue perfusion, with one view of the head unit 2105A showing the expansion flow element 2410A in a contracted state, and the other view of the head unit 2105B showing the expansion flow element 2410B in an expanded state. The expansion flow element 2410 may be useful when it is desirable to impart additional sealing capability to tissue that is coupled to the outflow port 15.

For example, if a heart 2420 is coupled to the outflow port 15 in conjunction with the expansion flow element 2410, the expansion flow element 2410 can expand to seal the aorta of the heart 2420 during the time perfusion fluid flows in pulses from the outflow port 15, to perfuse the heart 2420. In this manner, the expansion flow element 2410B effectively expands from its contracted state (as shown for element 2410A), to an expanded state 2410B, sealing the vascularized tissue of the heart's aorta against the incoming flow 2430 of perfusate during the increased pressure phase of each perfusion fluid pulse. The expansion flow element may comprise a relatively compliant material, such as medical grade rubber, or any other material that expands when subjected to the force of a perfusate pulse, taking the form of the flow 2430, when the interior pressure of the tissue compartment 18 is approximately 2 mm Hg to approximately 50 mm Hg.

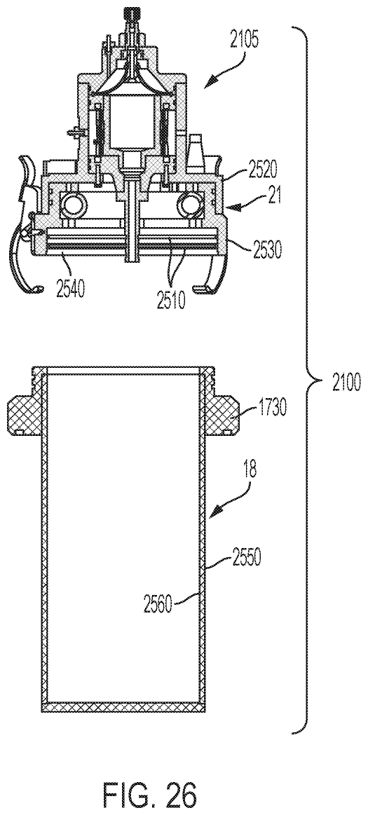

FIG. 26 is a side plan view of a fluid seal 2510 between the tissue compartment 18 and the head unit 2105 of an apparatus 2100 for vascular tissue perfusion. The fluid seal 2510 in this case comprises two O-rings that are disposed in-between the tissue compartment 18 and the housing 21 of the apparatus 2100. Here the housing 21 comprises an outer housing 2520 and an inner housing 2530, and the O-rings are disposed along an inner surface 2540 of the inner housing 2530. The O-rings may be shaped to fit into grooves formed in an interface plate extension 1730, described previously. The interface plate extension 1730 may be formed to accommodate the tissue compartment 18 along the exterior surface 2550 of the tissue compartment 18 (as shown in this figure), or along the interior surface 2560 of the tissue compartment 18, as shown in FIG. 17.

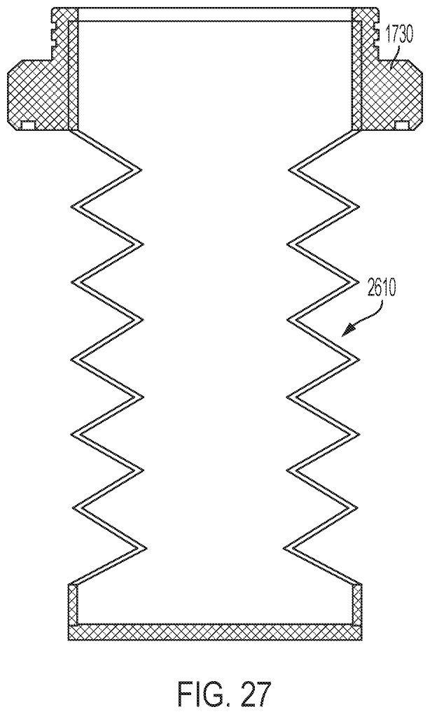

FIG. 27 is a side plan view of an expandable tissue compartment 2610 forming part of an apparatus for vascular tissue perfusion. Here the expandable tissue compartment 2610 is attached to an interface plate extension 1730, in a manner similar to what is shown in FIG. 25. And, as is the case for the tissue compartment 18 in FIG. 26, the interface plate extension 1730 may be formed to accommodate the expandable tissue compartment 2610 along the interior surface 2620 of the expandable tissue compartment 2610.

To add to the portable nature of various forms of the apparatus described herein, the expandable tissue compartment 2610 can be attached to the head unit 2105, as desired. This expandable tissue compartment 2610, as shown, has an accordion fold over the majority of its length, so that the expandable tissue compartment 2610 may easily be lengthened, or shortened, as desired, to accommodate a variety of tissue types, sizes, and shapes. The expandable tissue compartment 2610 may be made from a clear or colored flexible material, such as a polymer, including polyvinyl chloride (PVC) having a diameter and length that is sufficient to accommodate the entire length of vascularized tissue, such as an appendage (e.g., human hand, arm, or leg) or organ.

In the preceding discussion, the term “coupled” is defined as connected, although not necessarily directly, and not necessarily mechanically. Thus, one element may be directly, mechanically coupled to another, as is the case with the purge port 4 of the pumping diaphragm 24. An element may also be indirectly, fluidly coupled to another, as is the case (during operation) of the base plate 17 and the pumping membrane flange 3.

The use of the word “a” or “an” when used in conjunction with the term “comprising” in the claims and/or the specification may mean “one,” but it is also consistent with the meaning of “one or more” or “at least one.” The terms “about”, “approximately” or “substantially” mean, in general, the stated value plus or minus 5%. The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more acts or elements, possesses those one or more acts or elements, but is not limited to possessing only those one or more elements. Likewise, an act in a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

Thus, many variations of the invention may be realized. Several examples will now be described.

Optionally, in this example or in any of the examples disclosed herein, an apparatus for vascular tissue perfusion comprises: an oxygenator comprising a first end, a second end, and a plurality of conduits extending from the first end to the second end; and a flexible membrane comprising a first side and a second side, wherein: the first side of the flexible membrane is proximal to the first end of the oxygenator; the flexible membrane is configured to restrict fluid flow through the plurality of conduits when the second side of the flexible membrane is subjected to a higher pressure than the first side of the flexible membrane; and the flexible membrane is configured to allow fluid flow through the plurality of conduits when the first side of the flexible membrane is subjected to a higher pressure than the second side of the flexible membrane.

Optionally, in this example or in any of the examples disclosed herein, the flexible membrane is conical shaped, with a first end on the first side, and a second end on the second side. Optionally, in this example or in any of the examples disclosed herein, the first end of the conical membrane comprises a port and the second end comprises a flange. Optionally, in this example or in any of the examples disclosed herein, the flange of the flexible membrane is configured to deflect away from the first end of the oxygenator when the first side of the flexible membrane is subjected to a higher pressure than the second side of the flexible membrane. Optionally, in this example or in any of the examples disclosed herein, the flexible membrane is oxygen permeable.

Optionally, in this example or in any of the examples disclosed herein, the flexible membrane comprises a tapered portion having a first end and a second end, and wherein the first end has a smaller cross-sectional area than the second end.

Optionally, in this example or in any of the examples disclosed herein, the apparatus comprises a central channel, wherein: the plurality of conduits are located around the central channel; and the flexible membrane is configured to force fluid flow through the central channel when the second side of the flexible membrane is subjected to a higher pressure than the first side of the flexible membrane. Optionally, in this example or in any of the examples disclosed herein, the apparatus comprises a chamber extending from the central channel, wherein the plurality of conduits are located within the chamber. Optionally, in this example or in any of the examples disclosed herein, the chamber is in fluid communication with a source of pressurized oxygen. Optionally, in this example or in any of the examples disclosed herein, the apparatus comprises a compartment configured to contain vascular tissue, wherein: the central channel of the oxygenator is in fluid communication with the compartment configured to contain vascular tissue; and the compartment comprises an opening to an interior volume of the compartment. Optionally, in this example or in any of the examples disclosed herein, the apparatus comprises a housing coupled to the opening of the compartment, wherein the housing comprises a flexible base plate proximal to the interior volume of the compartment. Optionally, in this example or in any of the examples disclosed herein, the flexible base plate is configured to flex away from the interior volume of the compartment when the second side of the flexible membrane is subjected to a higher pressure than the first side of the flexible membrane. Optionally, in this example or in any of the examples disclosed herein, the apparatus comprises an outflow port coupled to the central channel of the oxygenator, wherein the outflow port is in fluid communication with the interior volume of the compartment. Optionally, in this example or in any of the examples disclosed herein, the apparatus comprises vascular tissue, wherein the vascular tissue is located in the compartment. Optionally, in this example or in any of the examples disclosed herein, the vascular tissue comprises an arterial vessel coupled to the outflow port. Optionally, in this example or in any of the examples disclosed herein, the apparatus comprises a tissue preservation solution in the compartment, the central channel of the oxygenator, and the plurality of conduits of the oxygenator. Optionally, in this example or in any of the examples disclosed herein the vascular tissue is contained in a limb.

Optionally, in this example or in any of the examples disclosed herein, the apparatus comprises a control system configured to pulse the higher pressure to the first side of the flexible member. Optionally, in this example or in any of the examples disclosed herein, the control system comprises a fluidic valve, including a microfluidic valve.

Optionally, in this example or in any of the examples disclosed herein, a method of vascular tissue perfusion comprises providing pressurized oxygen to a perfusion apparatus, wherein the pressurized oxygen is repetitively pulsed between a lower pressure and a higher pressure; directing perfusion fluid through vascular tissue to a compartment in the perfusion apparatus containing the vascular tissue when the pressurized oxygen is at the higher pressure; directing perfusion fluid from the compartment containing the vascular tissue to an oxygenator when the pressurized oxygen is at the lower pressure; and directing pressurized oxygen to the oxygenator to oxygenate perfusion fluid in the oxygenator when the pressurized oxygen pressure is at the lower pressure. Optionally, in this example or in any of the examples disclosed herein, the method is executed when the perfusion device comprises a chamber in fluid communication with a port and an exhaust orifice; the oxygenator comprises a plurality of conduits comprising the perfusion fluid, and the plurality of conduits are located within the chamber; and the method further comprises directing the pressurized oxygen to the oxygenator comprises directing the pressurized oxygen through the port, into the chamber, and out of the exhaust orifice.

Optionally, in this example or in any of the examples disclosed herein, the method comprises directing the pressurized oxygen through an entry orifice between the port and the chamber. Optionally, in this example or in any of the examples disclosed herein, directing the perfusion fluid through vascular tissue comprises deflecting a flexible membrane when the pressurized oxygen is at the higher pressure. Optionally, in this example or in any of the examples disclosed herein, the flexible membrane operates to direct fluid through a channel extending through a central portion of the oxygenator when the pressurized oxygen is at the higher pressure. Optionally, in this example or in any of the examples disclosed herein, a volume of the compartment containing the vascular tissue expands when perfusion fluid flows from the vascular tissue to the compartment containing the vascular tissue and/or the volume of the compartment containing the vascular tissue contracts when the pressurized oxygen is at the lower pressure. Optionally, in this example or in any of the examples disclosed herein, a flexible plate flexes to expand the volume of the compartment containing the vascular tissue and/or the flexible plate flexes to contract the volume of the compartment containing the vascular tissue. Optionally, in this example or in any of the examples disclosed herein, perfusion fluid is directed from the compartment containing the vascular tissue to the oxygenator when the flexible plate flexes. Optionally, in this example or in any of the examples disclosed herein, the pressurized oxygen is repetitively pulsed between the lower pressure and the higher pressure by opening and closing a fluidic or a microfluidic valve.

Optionally, in this example or in any of the examples disclosed herein, an apparatus for vascular tissue perfusion comprises: an oxygenator comprising a first end, a second end, and a plurality of conduits extending from the first end to the second end; a flexible membrane comprising a first side and a second side; and a compartment configured to contain vascular tissue, wherein the plurality of conduits are located around a channel, wherein: the flexible membrane is configured to force fluid flow through the channel when the second side of the flexible membrane is subjected to a higher pressure than the first side of the flexible membrane; the first side of the flexible membrane is proximal to the first end of the oxygenator; the flexible membrane is configured to restrict fluid flow through the plurality of conduits when the second side of the flexible membrane is subjected to a higher pressure than the first side of the flexible membrane; the flexible membrane is configured to allow fluid flow through the plurality of conduits when the first side of the flexible membrane is subjected to a higher pressure than the second side of the flexible membrane; and the channel of the oxygenator is configured to enable fluid communication with the compartment configured to contain vascular tissue.

Optionally, in this example or in any of the examples disclosed herein, the compartment comprises a flexible sleeve. Optionally, in this example or in any of the examples disclosed herein, one end of the compartment is sealed. Optionally, in this example or in any of the examples disclosed herein, the compartment is configured to enable a fluid-tight seal against a surface of a housing extension baseplate, when the housing extension baseplate is coupled with a fluid-tight seal to a housing containing the oxygenator. Optionally, in this example or in any of the examples disclosed herein, the compartment is configured to be cut to a desired length using a hand operated tool. Optionally, in this example or in any of the examples disclosed herein, the second end of the compartment comprises a flexible seal. Optionally, in this example or in any of the examples disclosed herein, the flexible seal comprises an inflatable cuff. Optionally, in this example or in any of the examples disclosed herein, the flexible seal is configured to seal to an appendage of a patient. Optionally, in this example or in any of the examples disclosed herein, the compartment comprises a fill port and a vent port.

Optionally, in this example or in any of the examples disclosed herein, an apparatus for vascular tissue perfusion comprises: an oxygenator comprising a first end, a second end, and a plurality of conduits extending from the first end to the second end; and a flexible membrane comprising a first side and a second side, wherein: the first side of the flexible membrane is proximal to the first end of the oxygenator; the flexible membrane is configured to restrict fluid flow through the plurality of conduits when the second side of the flexible membrane is subjected to a higher pressure than the first side of the flexible membrane; the flexible membrane is configured to allow fluid flow through the plurality of conduits when the first side of the flexible membrane is subjected to a higher pressure than the second side of the flexible membrane; the plurality of conduits are located around the central channel; the flexible membrane is configured to force fluid flow through the central channel when the second side of the flexible membrane is subjected to a higher pressure than the first side of the flexible membrane; and the plurality of conduits are bowed outward away from the central channel

Optionally, in this example or in any of the examples disclosed herein, an apparatus for vascular tissue perfusion comprises: an oxygenator comprising a first end, a second end, and a plurality of conduits extending from the first end to the second end; and a flexible membrane comprising a first side and a second side, wherein: the first side of the flexible membrane is proximal to the first end of the oxygenator; the flexible membrane is configured to restrict fluid flow through the plurality of conduits when the second side of the flexible membrane is subjected to a higher pressure than the first side of the flexible membrane; the flexible membrane is configured to allow fluid flow through the plurality of conduits when the first side of the flexible membrane is subjected to a higher pressure than the second side of the flexible membrane; the plurality of conduits are located around the central channel; the flexible membrane is configured to force fluid flow through the central channel when the second side of the flexible membrane is subjected to a higher pressure than the first side of the flexible membrane; and the first end of the oxygenator is rotated with respect to the second end of the oxygenator such that the plurality of conduits are not linear.

Optionally, in this example or in any of the examples disclosed herein, the first end of the oxygenator is rotated with respect to the second end of the oxygenator between five and sixty degrees. Optionally, in this example or in any of the examples disclosed herein, the first end of the oxygenator is rotated clockwise or counterclockwise with respect to the second end of the oxygenator when viewed from the second end of the oxygenator.

Optionally, in this example or in any of the examples disclosed herein, an apparatus for vascular tissue perfusion comprises an oxygenator comprising a first end, a second end, and a plurality of conduits extending from the first end to the second end; and a flexible membrane comprising a first side and a second side, wherein: the first side of the flexible membrane is proximal to the first end of the oxygenator; the flexible membrane is configured to restrict fluid flow through the plurality of conduits when the second side of the flexible membrane is subjected to a higher pressure than the first side of the flexible membrane; the flexible membrane is configured to allow fluid flow through the plurality of conduits when the first side of the flexible membrane is subjected to a higher pressure than the second side of the flexible membrane; the plurality of conduits are located around the central channel; the flexible membrane is configured to force fluid flow through the central channel when the second side of the flexible membrane is subjected to a higher pressure than the first side of the flexible membrane; and the plurality of conduits comprise helical conduits. Optionally, in this example or in any of the examples disclosed herein, the helical conduits comprise spirals formed in a clockwise or counter-clockwise direction when viewed from the second end of the oxygenator.

Optionally, in this example or in any of the examples disclosed herein, an apparatus for vascular tissue perfusion comprises: an oxygenator comprising a first end, a second end, and a plurality of oxygen-permeable conduits extending from the first end to the second end; a flexible membrane comprising a first side and a second side, wherein the first side of the flexible membrane is proximal to the first end of the oxygenator; the flexible membrane is configured to restrict fluid flow through the plurality of conduits when the second side of the flexible membrane is subjected to a higher pressure than the first side of the flexible membrane; and the flexible membrane is configured to allow fluid flow through the plurality of conduits when the first side of the flexible membrane is subjected to a higher pressure than the second side of the flexible membrane; a housing to contain the oxygenator and the flexible membrane; and a flexible compartment having an open end configured to couple to the housing with a fluid-tight seal. Optionally, in this example or in any of the examples disclosed herein, the apparatus comprises a housing baseplate extension to dispose between the housing and the compartment, to enlarge the diameter of the housing when the extension is coupled to the housing. Optionally, in this example or in any of the examples disclosed herein, the apparatus comprises a fluidic oscillator to enable feedback-controlled cycling between the higher pressure and the lower pressure.

Optionally, in this example or in any of the examples disclosed herein, an apparatus for vascular tissue perfusion comprises: a head unit comprising an oxygenator; a flexible membrane configured to allow fluid flow through a plurality of conduits in the oxygenator when a first side of the flexible membrane is subjected to a higher pressure than a second side of the flexible membrane; and a tissue compartment to be mechanically coupled to the head unit, wherein a compliance element is disposed within the tissue compartment or the head unit. Optionally, in this example or in any of the examples disclosed herein, the compliance element comprises a solid shape, or a hollow, closed shape, and wherein the compliance element is more compliant than the tissue compartment when subjected to a pressure range of approximately 2 mm Hg to approximately 50 mm Hg. Optionally, in this example or in any of the examples disclosed herein, the compliance element, when subjected to an external pressure range of approximately 2 mm Hg to approximately 50 mm Hg, compresses so as to increase available volume for the fluid flow to circulate within the tissue compartment and the head unit. Optionally, in this example or in any of the examples disclosed herein, the compliance unit comprises a hollow shape constructed with a selected wall thickness, material property, and/or size to respond to a selected frequency of pulsation of the oxygenator and/or pressure range of fluid flow proximate to the oxygenator.

Optionally, in this example or in any of the examples disclosed herein, an apparatus for vascular tissue perfusion comprises: a head unit comprising an oxygenator; a flexible membrane configured to allow fluid flow through a plurality of conduits in the oxygenator when a first side of the flexible membrane is subjected to a higher pressure than a second side of the flexible membrane; and a tissue compartment to be attached to the head unit, wherein a compliance element is disposed within the tissue compartment or the head unit.

Optionally, in this example or in any of the examples disclosed herein, an apparatus for vascular tissue perfusion comprises a head unit comprising an oxygenator; a flexible membrane configured to allow fluid flow through a plurality of conduits in the oxygenator when a first side of the flexible membrane is subjected to a higher pressure than a second side of the flexible membrane; and a compliance element disposed within the head unit.

Optionally, in this example or in any of the examples disclosed herein, an apparatus for vascular tissue perfusion comprises: a head unit comprising an oxygenator; a flexible membrane configured to allow fluid flow through a plurality of conduits in the oxygenator when a first side of the flexible membrane is subjected to a higher pressure than a second side of the flexible membrane; and a bifurcated flow element coupled to an outflow port of the head unit, or an expansion flow element coupled to an outflow port of the head unit.

Optionally, in this example or in any of the examples disclosed herein, an apparatus for vascular tissue perfusion comprises: a head unit comprising an oxygenator; a flexible membrane configured to allow fluid flow through a plurality of conduits in the oxygenator when a first side of the flexible membrane is subjected to a higher pressure than a second side of the flexible membrane; and a tissue compartment to be attached to the head unit with a fluid seal, or an expandable tissue compartment having an accordion fold, the expandable tissue compartment to be attached to the head unit.

Optionally, in this example or in any of the examples disclosed herein, an apparatus for vascular tissue perfusion comprises: an oxygenator comprising a first end, a second end, and a plurality of conduits extending from the first end to the second end; and a flexible membrane comprising a first side and a second side, wherein: the first side of the flexible membrane is proximal to the first end of the oxygenator; the flexible membrane is configured to restrict fluid flow through the plurality of conduits when the second side of the flexible membrane is subjected to a higher pressure than the first side of the flexible membrane; and the flexible membrane is configured to allow fluid flow through the plurality of conduits when the first side of the flexible membrane is subjected to a higher pressure than the second side of the flexible membrane.

Optionally, in this example or in any of the examples disclosed herein, the flexible membrane comprises a tapered portion having a first end and a second end, and wherein the first end of the flexible membrane has a smaller cross-sectional area than the second end of the flexible membrane. Optionally, in this example or in any of the examples disclosed herein, the first end of the flexible membrane comprises a port and the second end of the flexible membrane comprises a flange.

Optionally, in this example or in any of the examples disclosed herein, the apparatus comprises a central channel, wherein: the plurality of conduits are located around the central channel; and the flexible membrane is configured to force fluid flow through the central channel when the second side of the flexible membrane is subjected to a higher pressure than the first side of the flexible membrane.

Optionally, in this example or in any of the examples disclosed herein, the apparatus comprises a compartment configured to contain vascular tissue, wherein: the central channel of the oxygenator is in fluid communication with the compartment configured to contain vascular tissue; and the compartment comprises an opening to an interior volume of the compartment.

Optionally, in this example or in any of the examples disclosed herein, the apparatus comprises a housing to contain the oxygenator; and a housing baseplate extension to dispose between the housing and a tissue compartment, to enlarge the diameter of the housing when the extension is coupled to the housing.

Optionally, in this example or in any of the examples disclosed herein, the apparatus comprises a fluidic oscillator to enable feedback-controlled cycling between the higher pressure and the lower pressure.

Optionally, in this example or in any of the examples disclosed herein, the apparatus comprises a head unit containing the oxygenator; a tissue compartment fluidly coupled to the head unit; and a compliance element disposed within the head unit or the tissue compartment.

Optionally, in this example or in any of the examples disclosed herein, the compliance element comprises a solid shape, or a hollow, closed shape, wherein the compliance element is more compliant than the tissue compartment when subjected to a pressure range of approximately 2 mm Hg to approximately 50 mm Hg. Optionally, in this example or in any of the examples disclosed herein, the compliance element, when subjected to an external pressure range of approximately 2 mm Hg to approximately 50 mm Hg, compressible so as to increase available volume for the fluid flow to circulate within the tissue compartment and the head unit. Optionally, in this example or in any of the examples disclosed herein, the the compliance element comprises a hollow shape constructed with a selected wall thickness, material property, and/or size to respond to a selected frequency of pulsation of the oxygenator and/or pressure range of fluid flow proximate to the oxygenator.

Optionally, in this example or in any of the examples disclosed herein, a method of vascular tissue perfusion comprises: providing pressurized oxygen to a perfusion apparatus, wherein the pressurized oxygen is repetitively pulsed between a lower pressure and a higher pressure; directing perfusion fluid through vascular tissue to a compartment in the perfusion apparatus containing the vascular tissue when the pressurized oxygen is at the higher pressure; directing the perfusion fluid from the compartment containing the vascular tissue to an oxygenator when the pressurized oxygen is at the lower pressure; and directing pressurized oxygen to the oxygenator to oxygenate the perfusion fluid in the oxygenator when the pressurized oxygen pressure is at the lower pressure. Optionally, in this example or in any of the examples disclosed herein, the perfusion device comprises a chamber in fluid communication with a port and an exhaust orifice; the oxygenator comprises a plurality of conduits comprising the perfusion fluid, and the plurality of conduits are located within the chamber; and the method comprises directing the pressurized oxygen to the oxygenator comprises directing the pressurized oxygen through the port, into the chamber, and out of the exhaust orifice. Optionally, in this example or in any of the examples disclosed herein, directing the perfusion fluid through vascular tissue comprises compressing a compliance element when the pressurized oxygen is at the higher pressure. Optionally, in this example or in any of the examples disclosed herein, a flexible membrane operates to direct fluid through a channel extending through a central portion of the oxygenator when the pressurized oxygen is at the higher pressure. Optionally, in this example or in any of the examples disclosed herein, the pressurized oxygen is repetitively pulsed between the lower pressure and the higher pressure by opening and closing a fluidic valve.

Optionally, in this example or in any of the examples disclosed herein, a system for vascular tissue perfusion comprises a head unit comprising an oxygenator; a flexible membrane configured to allow fluid flow through a plurality of conduits in the oxygenator when a first side of the flexible membrane is subjected to a higher pressure than a second side of the flexible membrane; a tissue compartment to be attached to the head unit; a tank to hold oxygen; and a fluidic valve coupled to the tank and the head unit. Optionally, in this example or in any of the examples disclosed herein, the system comprises a compliance element disposed within the tissue compartment or the head unit. Optionally, in this example or in any of the examples disclosed herein, the system comprises a tissue preservation solution in the tissue compartment, a central channel of the oxygenator, and the plurality of conduits. Optionally, in this example or in any of the examples disclosed herein, the system for vascular tissue perfusion comprises a control system configured to pulse the higher pressure to the first side of the flexible membrane. Optionally, in this example or in any of the examples disclosed herein, the system comprises an expandable tissue compartment having an accordion fold, the expandable tissue compartment to be attached to the head unit.

All of the apparatus, systems and/or methods disclosed and claimed herein can be made and executed without undue experimentation in light of the present disclosure. While these apparatus, systems and methods have been described in terms of particular examples, it will be apparent to those of ordinary skill in the art that variations may be applied to the apparatus, systems and/or methods without departing from the scope of this disclosure. All such similar substitutes and modifications apparent to those of ordinary skill in the art are deemed to be within the scope of this disclosure, as defined by the appended claims.

1. An apparatus for vascular tissue perfusion, the apparatus comprising:
a head unit comprising an oxygenator, the oxygenator comprising a plurality of conduits extending from a first end of the oxygenator to a second end of the oxygenator;
a tissue compartment to be fluidly coupled to the head unit;
a compliance element disposed within the head unit or the tissue compartment;
and
a flexible membrane comprising a first side and a second side, wherein:
the first side of the flexible membrane is proximal to the first end of the oxygenator; the flexible membrane is configured to restrict fluid flow through the plurality of conduits when the second side of the flexible membrane is subjected to a higher
pressure than the first side of the flexible membrane; and the flexible membrane is configured to allow fluid flow through the plurality of conduits when the first side of the flexible membrane is subjected to a higher pressure than the second side of the flexible membrane.

2. The apparatus of claim 1 wherein the flexible membrane comprises a tapered portion having a first end and a second end, and wherein the first end of the flexible membrane has a smaller cross-sectional area than the second end of the flexible membrane.

3. The apparatus of claim 2 wherein the first end of the flexible membrane comprises a port and the second end of the flexible membrane comprises a flange.

4. The apparatus of claim 1 further comprising a central channel, wherein:
the plurality of conduits are located around the central channel; and
the flexible membrane is configured to force fluid flow through the central channel when the second side of the flexible membrane is subjected to a higher pressure than the first side of the flexible membrane.

5. The apparatus of claim 4, further comprising a compartment configured to contain vascular tissue, wherein:
the central channel of the oxygenator is in fluid communication with the compartment configured to contain vascular tissue; and the compartment comprises an opening to an interior volume of the compartment.

6. The apparatus of claim 1, further comprising a housing baseplate extension to dispose between the head unit and the tissue compartment, to enlarge the diameter of the head unit when the housing baseplate extension is coupled to the head unit.

7. The apparatus of claim 1, further comprising a fluidic oscillator to enable feedback-controlled cycling between the higher pressure and the lower pressure.

8. The apparatus of claim 1, wherein the compliance element comprises a solid shape, or a hollow, closed shape, and wherein the compliance element is more compliant than the tissue compartment when subjected to a pressure range of approximately 2 mm Hg to approximately 50 mm Hg.

9. The apparatus of claim 1, wherein the tissue compartment, the compliance element, when subjected to an external pressure range of approximately 2 mm Hg to approximately 50 mm Hg, is compressible so as to increase available volume for fluid flow to circulate within the tissue compartment and the head unit when the tissue compartment is fluidly coupled to the head unit.

10. The apparatus of claim 1, wherein the compliance element comprises a hollow shape constructed with a selected wall thickness, material property, and/or size to respond to a selected frequency of pulsation of the oxygenator and/or pressure range of fluid flow proximate to the oxygenator.

11. A method of vascular tissue perfusion, the method comprising:
providing pressurized oxygen to a perfusion apparatus, wherein the pressurized oxygen is repetitively pulsed between a lower pressure and a higher pressure; directing perfusion fluid through vascular tissue to a compartment in the perfusion apparatus containing the vascular tissue when the pressurized oxygen is at the higher pressure; directing the perfusion fluid from the compartment containing the vascular tissue to an oxygenator when the pressurized oxygen is at the lower pressure; and directing pressurized oxygen to a plurality of conduits in the oxygenator, the plurality of conduits extending from a first end of the oxygenator to a second end of the oxygenator, to oxygenate the perfusion fluid in the oxygenator when the pressurized oxygen pressure is at the lower pressure, wherein a compliance element is disposed within a head unit comprising the oxygenator, or a tissue compartment containing the vascular tissue, to provide volumetric compliance to the tissue compartment.

12. The method of claim 11 wherein:
the perfusion device comprises a chamber in fluid communication with a port and an exhaust orifice; and directing the pressurized oxygen to the oxygenator comprises directing the pressurized oxygen through the port, into the chamber, and out of the exhaust orifice.

13. The method of claim 11 wherein directing the perfusion fluid through vascular tissue comprises compressing the compliance element when the pressurized oxygen is at the higher pressure.

14. The method of claim 11 wherein a flexible membrane operates to direct fluid through a channel extending through a central portion of the oxygenator when the pressurized oxygen is at the higher pressure.

15. The method of claim 11, wherein the pressurized oxygen is repetitively pulsed between the lower pressure and the higher pressure by opening and closing a fluidic valve.

16. A system for vascular tissue perfusion, the system comprising:
a head unit comprising an oxygenator;
a flexible membrane configured to allow fluid flow through a plurality of conduits in the oxygenator when a first side of the flexible membrane is subjected to a higher pressure than a second side of the flexible membrane;
a tissue compartment to be attached to the head unit;
a compliance element disposed within the tissue compartment or the head unit;
a tank to hold oxygen; and
a fluidic valve coupled to the tank and the head unit.

17. The system of claim 16, further comprising:
a housing baseplate extension to dispose between the head unit and the tissue compartment, to enlarge the diameter of the housing when the housing baseplate extension is coupled to the head unit.

18. The system of claim 16, further comprising:
a tissue preservation solution in the tissue compartment.

19. The system of claim 16, further comprising:
a control system configured to pulse the higher pressure to the first side of the flexible membrane.

20. The system of claim 16, wherein the tissue compartment comprises:
an expandable tissue compartment having an accordion fold.
